(19) United States
(12) Patent Application Publication
(10) Pub. No.: US 2017/0038203 A1
(43) Pub. Date: Feb. 9, 2017

(54) SELF-PROPELLED DEVICE AND DISTANCE DETECTOR THEREOF

(71) Applicants: Sintai Optical (Shenzhen) Co., Ltd., Shenzhen City (CN); Asia Optical International Ltd., Tortola (GB)

(72) Inventors: Hua-Tang Liu, Taichung (TW); Chin-Hsiang Wang, Taichung (TW); Hsien-Chi Lin, Taichung (TW)

(21) Appl. No.: 15/201,644

(22) Filed: Jul. 5, 2016

(30) Foreign Application Priority Data
Aug. 6, 2015 (CN) 201510477283.3

(51) Int. Cl. G01C 3/08; A47L 11/40; G01D 5/347

(52) U.S. Cl. CPC G01C 3/08; G01D 5/3473; A47L 11/4011; A47L 2201/04

(57) ABSTRACT

A distance detector includes a main body, a laser emitting module, an image capturing module, an angle detecting mechanism, and a processing-control unit. The main body is configured to rotate about an axis. The laser emitting module is disposed on the main body and configured to emit a laser beam to a measured object, thereby forming a laser speckle thereon. The image capturing module is disposed on the main body and configured to capture an image of the measured object, which contains the laser speckle. The angle detecting mechanism is configured to detect an angular displacement of the main body from a starting position and generate angle data. The processing-control unit is configured to receive the image containing the laser speckle and the angle data to control rotation of the main body. A distance between the main body and the measured object is determined by using a triangulation method.

### BACKGROUND OF THE INVENTION

### Field of the Invention

The invention relates to a self-propelled device and a distance detector thereof, in which a non-diffractive laser beam is used and a scan is performed by means of a clockwise rotation or a counterclockwise rotation in a specific angular range.

### Description of the Related Art

A known self-propelled device, for example, an automatic guided vehicle (AGV) or a robotic vacuum cleaner, generally has an environment distance detector to measure the distances from surrounding objects so as to be well aware of the environment and organize the paths of movement of the self-propelled device.

Generally, a known environment distance detector measures distances by using a laser beam to perform a 360° surrounding scan. However, if a local change happens in the environment (for example, someone suddenly shows up in the environment), the environment distance detector will perform a 360° surrounding scan again even if only a local detection is required. That is time-consuming and inconvenient.

In a laser triangulation method, a laser beam is emitted to a measured object for forming a laser speckle thereon. The image of the measured object is captured for obtaining the coordinates of the laser speckle. Then, the distance of the measured object can be determined by using the triangulation method. However, for a distant object, the changes of the coordinates of the laser speckle are not obvious. Therefore, a higher recognition on the laser speckle is required when a distant object is detected. However, a laser beam propagating a long distance diverges so that the shape and dimensions of the laser speckle are changed and the distance of the distant object cannot be accurately measured.

### BRIEF SUMMARY OF THE INVENTION

The invention provides a distance detector which includes an angle detecting mechanism to detect and control the angular displacement of the distance detector. The distance detector is able to scan a local change in the environment, without a requirement for repeating a 360° surrounding san. Further, the distance detector of the invention uses a non-diffractive laser beam to measure the distance. The shape and dimensions of the laser speckle are less affected by the distances of the measured objects, wherein the distances may be different. Therefore, the measurements are always accurate.

The distance detector in accordance with an exemplary embodiment of the invention includes a main body, a laser emitting module, an image capturing module, an angle detecting mechanism, and a processing-control unit. The main body is configured to rotate about an axis. The laser emitting module is disposed on the main body and configured to emit a laser beam to a measured object, thereby forming a laser speckle on the measured object. The image capturing module is disposed on the main body and configured to capture an image of the measured object, which contains the laser speckle. The angle detecting mechanism is configured to detect an angular displacement of the main body from a starting position and generate angle data. The processing-control unit is configured to receive the image containing the laser speckle and the angle data to control rotation of the main body. A distance between the main body and the measured object is determined by using a triangulation method. A virtual triangle for the triangulation method is formed by connecting locations of the laser emitting module, the image capturing module and the laser speckle.

In another exemplary embodiment, the laser beam is a non-diffractive laser beam.

In yet another exemplary embodiment, the angle detecting mechanism includes an encoder disk, a light source and a light receiver. The encoder disk is joined to the main body and includes a plurality of slits. The light source is configured to emit light which passes through the slits. The light receiver is configured to receive the light passing through the slits and generate the angle data. The light source and the light receiver are disposed on opposite sides of the encoder disk.

In another exemplary embodiment, the distance detector further includes a driving device wherein the processing-control unit is further configured to control the driving device to rotate the main body about the axis.

In yet another exemplary embodiment, the driving device includes a motor.

In another exemplary embodiment, the driving device further comprises a transmission element which connects the motor to the main body so that the main body is driven by the motor through the transmission element to rotate about the axis.

In yet another exemplary embodiment, the distance detector further includes a mount on which the driving device is mounted.

In another exemplary embodiment, the main body is configured to rotate to the angular displacement clockwise or counterclockwise.

In yet another exemplary embodiment, the laser beam propagates at an angle from an optical axis of the image capturing module.

In another exemplary embodiment, a distance detector includes a main body, a laser emitting module, an image capturing module, an angle detecting mechanism, and a processing-control unit. The main body is configured to rotate about an axis. The laser emitting module is disposed on the main body and configured to emit a laser beam to a measured object, thereby forming a laser speckle on the measured object. The image capturing module is disposed on the main body and configured to capture an image of the measured object, which contains the laser speckle. The angle detecting mechanism is configured to detect an angular displacement of the main body from a starting position and generate angle data. The processing-control unit is electrically connected to the image capturing module and the angle detecting mechanism for receiving the image comprising the laser speckle and the angle data to control rotation of the main body. The image of the laser speckle is used to determine a distance between the main body and the measured object by the processing-control unit for controlling the rotation of the main body.

The invention further provides a self-propelled device including the distance detector described above.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of a distance detector in accordance with an embodiment of the invention.

FIG. 2 is another perspective view of the distance detector of FIG. 1.

FIG. 3 is a block diagram of the distance detector of FIG. 1.

FIG. 4 is a top view of the distance detector of FIG. 1.

FIG. 5 depicts the distance detector of FIG. 4 in which some elements are removed.

FIG. 6 is an exploded view of a laser emitting module of the distance detector of FIG. 1.

FIG. 7 depicts a triangulation method used by the distance detector of the invention.

FIG. 8 is a bottom view of the distance detector of FIG. 1.

FIG. 9 is a side view of the distance detector of FIG. 1.

### DETAILED DESCRIPTION OF THE INVENTION

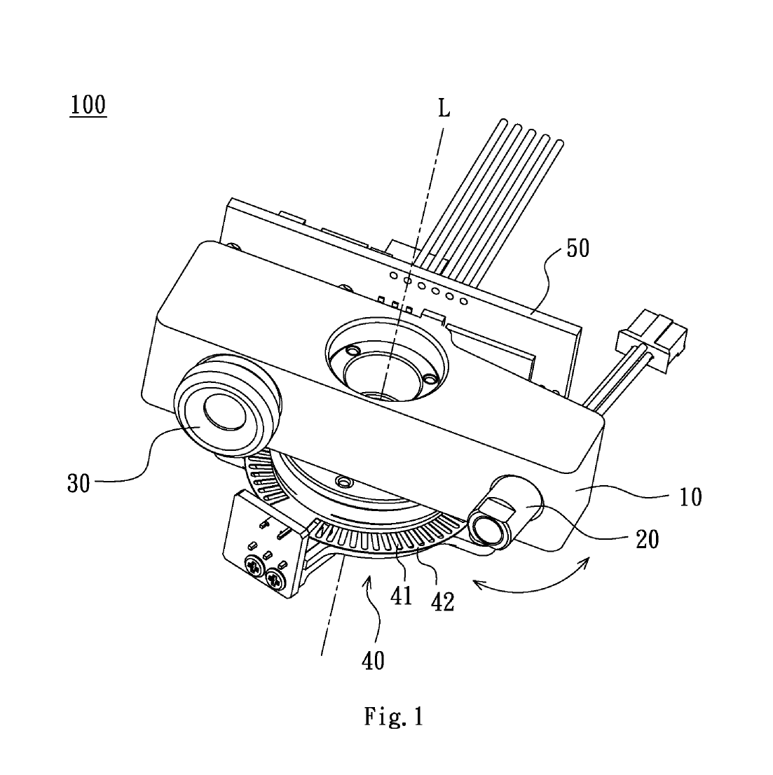

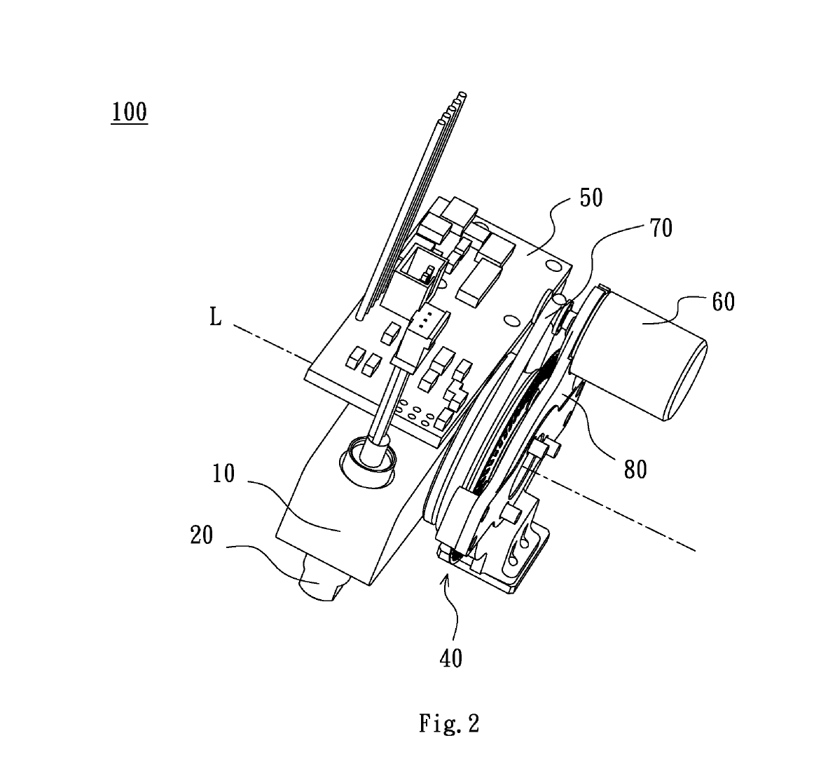

Referring to FIGS. 1, 2 and 3, a distance detector 100 in an embodiment of the invention includes a main body 10, a laser emitting module 20, an image capturing module 30, an angle detecting mechanism 40, a circuit board 50, a driving device 60, a transmission element 70 and a mount 80.

The mount 80 is fixed to a self-propelled device (not shown). The driving device 60 is mounted on the mount 80. The main body is rotatably joined to the mount 80. The driving device 60 is connected to the main body 10 through the transmission element 70. Therefore, the driving device 60 is capable of driving the main body 10 through the transmission element 70 to rotate with respect to the mount 80 about an axis L. In this embodiment, the driving device 60 is a motor and the transmission element 70 is a transmission belt.

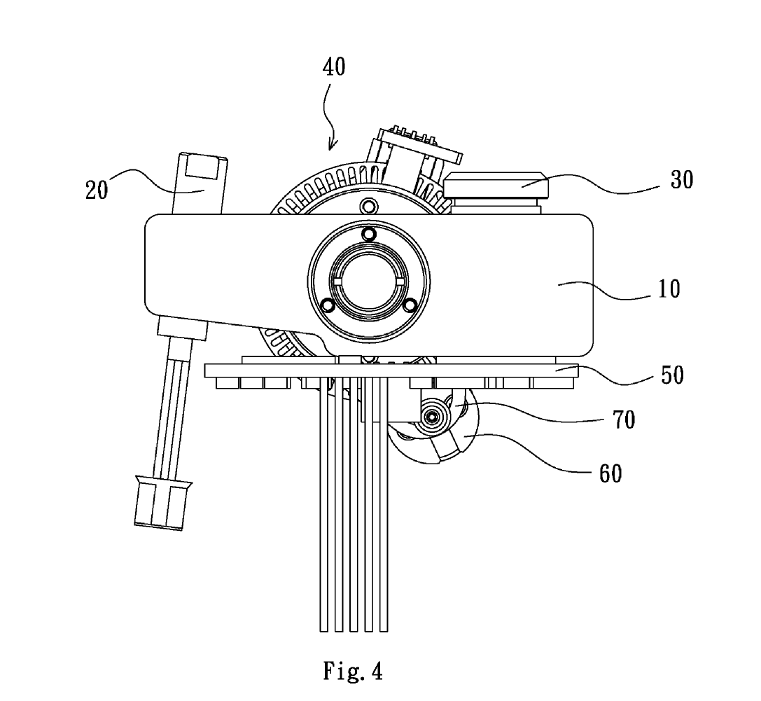

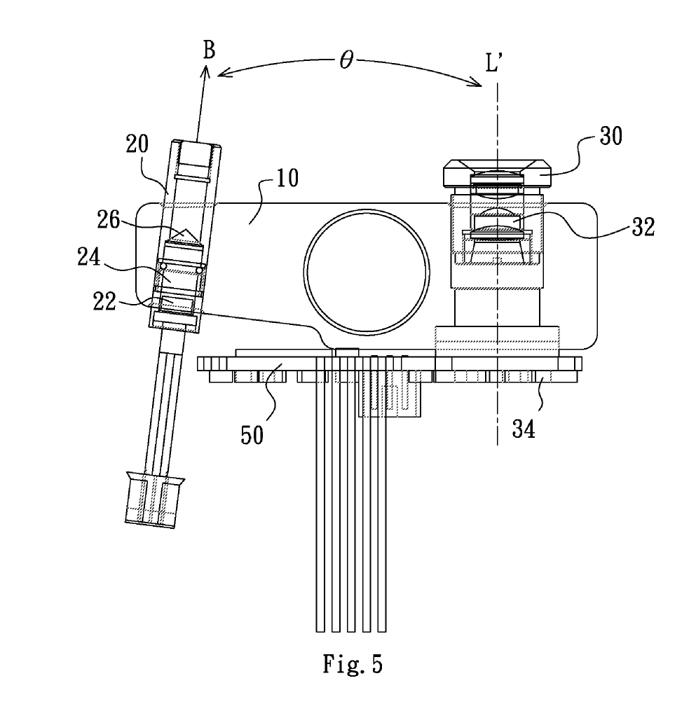

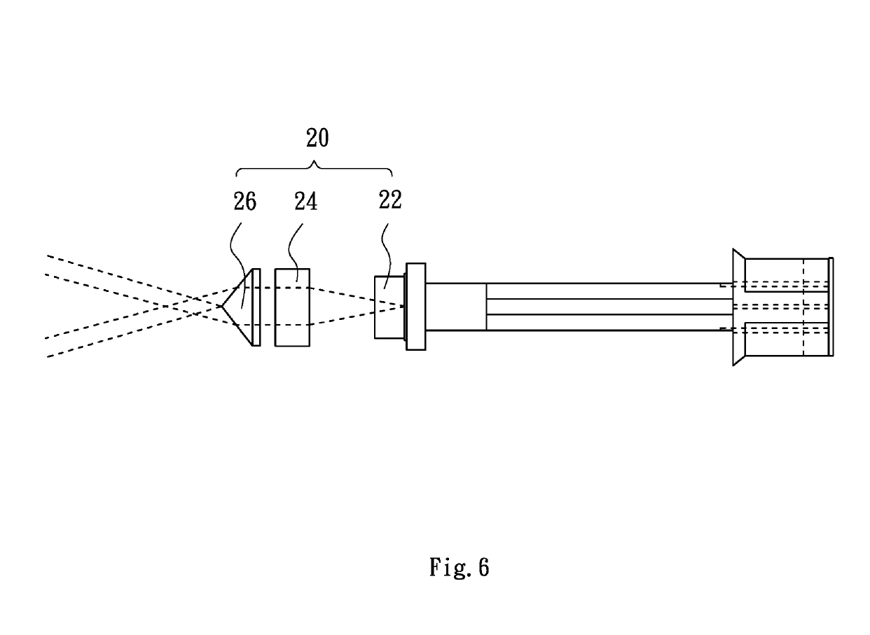

The laser emitting module 20, the image capturing module 30 and the circuit board 50 are mounted on the main body 10, thus following the main body 10 to rotate about the axis L. FIG. 4 and FIG. 5 are different views showing the laser emitting module 20, the image capturing module 30 and the circuit board 50 mounted on the main body 10. Referring to FIG. 6, the laser emitting module 20 of the invention includes a laser diode 22, a collimating lens 24 and a conical lens 26. In operation, the laser diode 22 generates a laser beam. The laser beam passes through the collimating lens 24 and turns into a parallel beam. The parallel beam passes through the conical lens 26 and turns into a non-diffractive laser beam. Referring to FIG. 5, the image capturing module 30 includes a lens assembly 32 and an image sensor 34. The image sensor 34 is disposed on the circuit board 50. In this embodiment, a laser beam B emitted by the laser emitting module 20 propagates at an angle θ from an optical axis L′ of the lens assembly 32 of the image capturing module 30, and θ=83°.

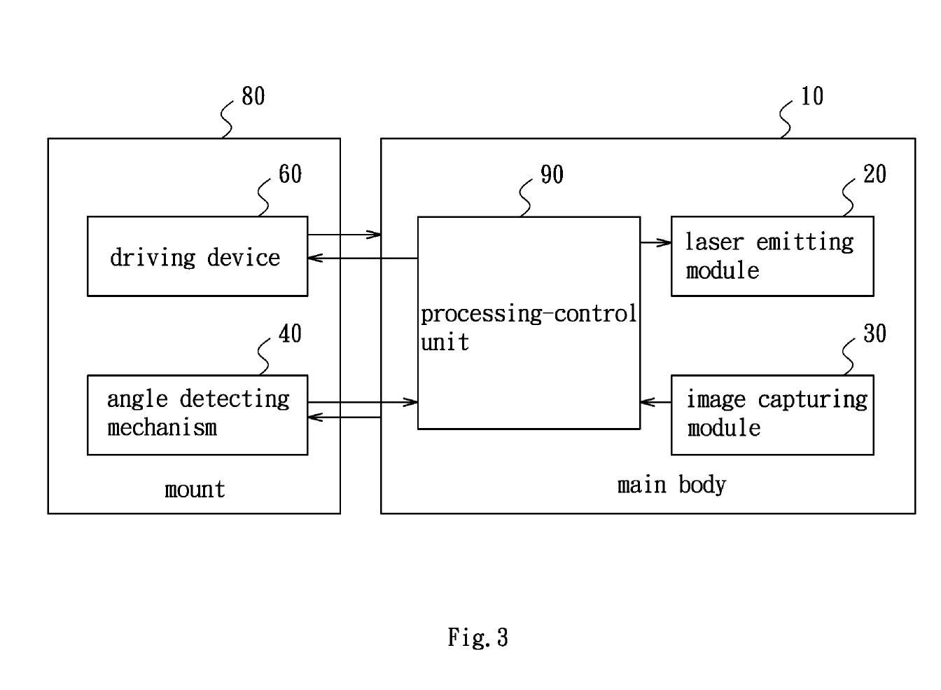

The distance detector of the invention uses a laser triangulation method to measure the distance. In operation, the laser emitting module 20 emits a laser beam to a measured object, thereby forming a laser speckle on the measured object. The image capturing module 30 captures an image of the measured object, which contains the laser speckle. The image of the measured object is received by the image sensor 34 through the lens assembly 32 and transmitted to a processing-control unit 90 (FIG. 3). The processing-control unit 90 calculates the coordinates of the center of the laser speckle for determining the distance of the measured object by using the triangulation method. The laser beam emitted by the laser emitting module 20 is a non-diffractive laser beam which is suitably used as an indicating beam in a precision measurement because the formed laser speckle is small and the dimensions of the laser speckle are less affected by the measured distance. By use of a non-diffractive laser beam, the measurement is accurate even when the measured object is distant.

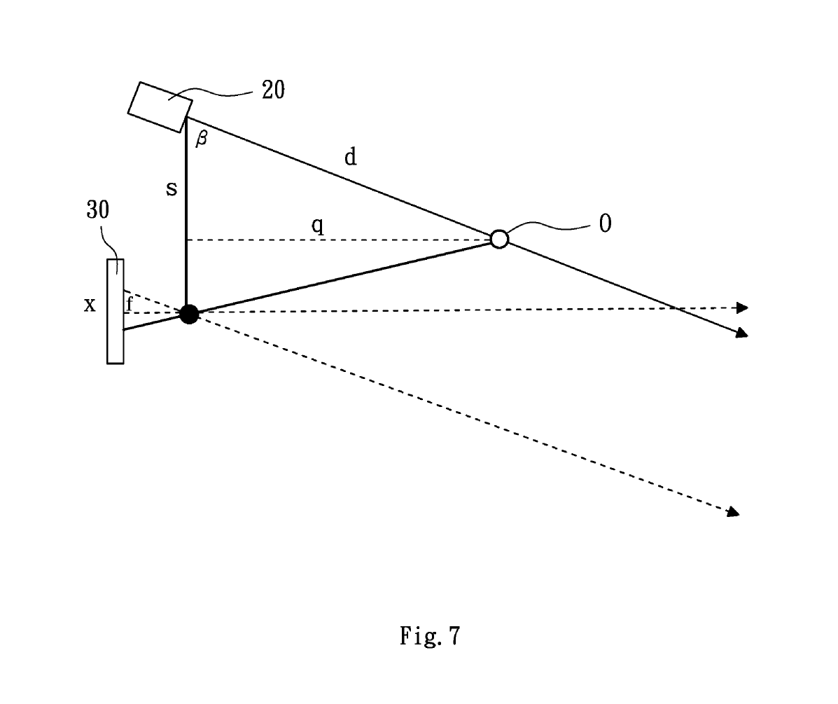

Referring to FIG. 7, a virtual triangle for the triangulation method is formed by connecting locations of the laser emitting module 20, the image capturing module 30 and the laser speckle. The formulas of the triangulation method are shown below:

Q=f·s/x (1)

d=q/sin(β) (2)

wherein f is the focal length of the image capturing module 30, s is the distance between the laser center of the laser emitting module 20 and the lens center of the image capturing module 30, β is the angle between the laser beam and the line passes through the laser center and the lens center, d is the distance between the laser center and the measured object O, and x is the distance between an edge and the location of the laser beam projected onto the measured object and captured by the image capturing module 30 to form an image on the image sensor, for example, a Charge-Coupled Device (CCD) or a Complementary Metal-Oxide-Semiconductor (CMOS). x is the only parameter required to be determined in the triangulation method. In this embodiment, x is obtained by observing the image captured by the image capturing module 30 and calculating the coordinates of the location of the laser beam projected onto the measured object.

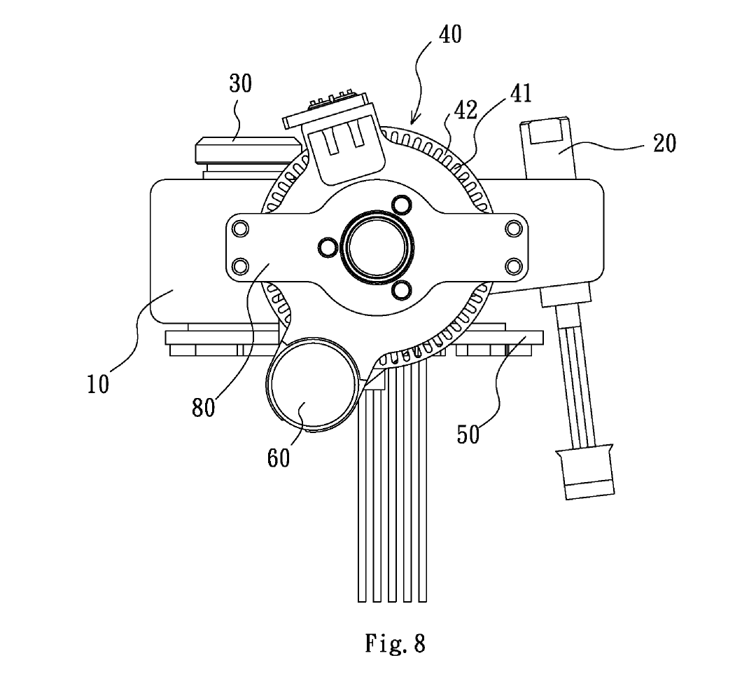

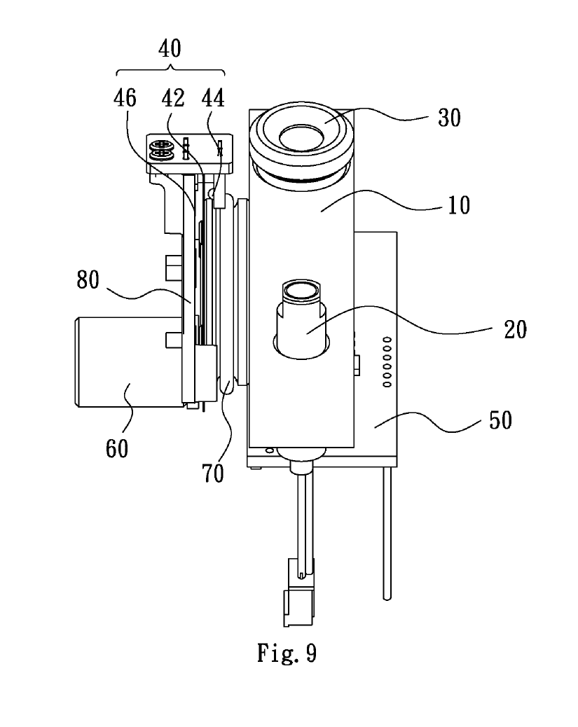

Referring to FIGS. 8 and 9, the angle detecting mechanism 40 includes an encoder disk 42, a light source 44 and a light receiver 46. The encoder disk 42 is joined to the main body 10 and rotatable together with the main body 10 about the axis L. The light source 44 and the light receiver 46 are mounted on the mount 80 and disposed on opposite sides of the encoder disk 42. As described, the main body 10 is rotatable about the axis L with respect to the mount 80. Therefore, the encoder disk 42 is rotatable with respect to the light source 44 and the light receiver 46. The encoder disk 42 is substantially circular and has a plurality of slits 41 circumferentially provided and equally spaced. Light emitted by the light source 44 passes through the slits 41 to be received by the light receiver 46 or is blocked by the encoder disk 42. Light from the light source 44 received by the light receiver 46 is deemed an ON signal, while no light received by the light receiver 46 is deemed an OFF signal. By such an arrangement, angle data are obtained and the angular displacement of the encoder disk 42 is determined. Further, the angular displacement of the main body 10 is determined because the encoder disk 42 is joined to the main body 10. The angle data are transmitted to the processing-control unit 90 for determining the angular displacement of the main body 10. By using the angular displacement of the main body 10, the processing-control unit 90 is capable of controlling the driving device 60 to rotate the main body 10 clockwise or counterclockwise to an angle, or to rotate the main body 10 back and forth in an angular range. It is understood that a 360° clockwise or counterclockwise rotation can be also performed. Accordingly, the distance detector 100 of the invention is capable of performing various types of scans and distance measurements.

A distance detector 100 in another embodiment of the invention includes a main body 10, a laser emitting module 20, an image capturing module 30, an angle detecting mechanism 40 and a processing-control unit 90. The main body is rotatable about an axis L. The laser emitting module 20 is mounted on the main body 10 for emitting a laser beam to a measured object and forming a laser speckle thereon. The image capturing module 30 is mounted on the main body 10 for capturing an image of the measured object, which contains the laser speckle. The angle detecting mechanism 40 is configured to detect an angular displacement of the main body 10 from a starting position and generate angle data. The processing-control unit 90, electrically connected to the image capturing module 30 and the angle detecting mechanism 40, receives the image containing the laser speckle, calculates the distance of the measured object and the angle data, and controls rotation of the main body 10. In this embodiment, a triangulation method of FIG. 7 is also used for determining the distance.

The distance detector of the invention can be installed in a self-propelled device such as a robotic vacuum cleaner to detect the environment by a 360° surrounding san. When a local change happens in the environment (for example, someone suddenly shows up in the environment), the distance detector 100 of the invention is able to repeatedly scan the local change in the environment. Further, a low detectable object can be repeatedly and rapidly scanned by the distance detector 100 of the invention.

The invention using a laser speckle and triangulation method to measure the distance differs from the known self-propelled devices using laser flight time and phases to measure the distance. A combination of the triangulation method and a laser speckle is applicable to a three-dimensional distance measurement and able to build a geometrical model for the environment, thus expanding the applications of the self-propelled devices. The angle detecting mechanism 40 uses a circular encoder disk 42 as an encoder to measure the angles. Thus, the scan can be performed by means of a clockwise rotation or a counterclockwise rotation, or at a specific angle and in a specific direction, or in a specific angular range. Further, the scan can be repeatedly and rapidly performed when the object is low detectable. The distance detector 100 of the invention uses a non-diffractive laser beam which has the features in that the formed laser speckle is small and the dimensions of the laser speckle are less affected by the measured distance. Therefore, the problem of a known Gaussian laser beam in which the laser speckle expands because of a distant measurement can be avoided. The distance and accuracy of the measurement can be increased.

The distance data obtained by the distance detector 100 of the invention can be shown by a display mounted on the main body 10, wirelessly transmitted to a portable device and shown by the display thereof, stored in a secure digital memory card (SD/mini SD/micro SD card), stored in the cloud, or expressed via video and/or audio.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A distance detector, comprising:
a main body configured to rotate about an axis;
a laser emitting module disposed on the main body and configured to emit a laser beam to a measured object, thereby forming a laser speckle on the measured object;
an image capturing module disposed on the main body and configured to capture an image of the measured object, which comprises the laser speckle;
an angle detecting mechanism configured to detect an angular displacement of the main body from a starting position and generate angle data; and
a processing-control unit configured to receive the image comprising the laser speckle and the angle data to control rotation of the main body;
wherein a distance between the main body and the measured object is determined by using a triangulation method;
wherein a virtual triangle for the triangulation method is formed by connecting locations of the laser emitting module, the image capturing module and the laser speckle.

2. The distance detector as claimed in claim 1, wherein the laser beam is a non-diffractive laser beam.

3. The distance detector as claimed in claim 1, wherein the angle detecting mechanism comprises:
an encoder disk joined to the main body and comprising a plurality of slits;
a light source configured to emit light which passes through the slits; and
a light receiver configured to receive the light passing through the slits and generate the angle data;
wherein the light source and the light receiver are disposed on opposite sides

4. The distance detector as claimed in claim 1, further comprising a driving device wherein the processing-control unit is further configured to control the driving device to rotate the main body about the axis.

5. The distance detector as claimed in claim 4, wherein the driving device comprises a motor.

6. The distance detector as claimed in claim 5, wherein the driving device further comprises a transmission element which connects the motor to the main body so that the main body is driven by the motor through the transmission element to rotate about the axis.

7. The distance detector as claimed in claim 4, further comprising a mount on which the driving device is mounted.

8. The distance detector as claimed in claim 1, wherein the main body is configured to rotate to the angular displacement clockwise or counterclockwise.

9. The distance detector as claimed in claim 1, wherein the laser beam propagates at an angle from an optical axis of the image capturing module.

10. A self-propelled device comprising the distance detector as claimed in claim 1.

11. A distance detector, comprising:
a main body configured to rotate about an axis;
a laser emitting module disposed on the main body and configured to emit a laser beam to a measured object, thereby forming a laser speckle on the measured object;
an image capturing module disposed on the main body and configured to capture an image of the measured object, which comprises the laser speckle;
an angle detecting mechanism configured to detect an angular displacement of
a processing-control unit electrically connected to the image capturing module and the angle detecting mechanism for receiving the image comprising the laser speckle and the angle data to control rotation of the main body;
wherein the image of the laser speckle is used to determine a distance between the main body and the measured object by the processing-control unit for controlling the rotation of the main body.

12. The distance detector as claimed in claim 11, wherein the laser beam is a non-diffractive laser beam.

13. The distance detector as claimed in claim 11, wherein the angle detecting mechanism comprises:
an encoder disk joined to the main body and comprising a plurality of slits;
a light source configured to emit light which passes through the slits; and
a light receiver configured to receive the light passing through the slits and generate the angle data;
wherein the light source and the light receiver are disposed on opposite sides of the encoder disk.

14. The distance detector as claimed in claim 11, further comprising a driving device wherein the processing-control unit is further configured to control the driving device to rotate the main body about the axis.

15. The distance detector as claimed in claim 14, wherein the driving device comprises a motor.

16. The distance detector as claimed in claim 15, wherein the driving device further comprises a transmission element which connects the motor to the main body so that the main body is driven by the motor through the transmission element to rotate about the axis.

17. The distance detector as claimed in claim 14, further comprising a mount

18. The distance detector as claimed in claim 11, wherein the main body is configured to rotate to the angular displacement clockwise or counterclockwise.

19. The distance detector as claimed in claim 11, wherein the laser beam propagates at an angle from an optical axis of the image capturing module.

20. A self-propelled device comprising the distance detector as claimed in claim 11.
